(19) United States
(12) Patent Application Publication
(10) Pub. No.: US 2025/0147144 A1
(43) Pub. Date: May 8, 2025

(54) 3D GUNSHOT LOCALIZATION, TRACKING, AND AI ENHANCED SYSTEM FOR SUBSTATION SECURITY

(71) Applicant: NEC Laboratories America, Inc., Princeton, NJ (US)

(72) Inventors: Yangmin DING, EAST BRUNSWICK, NJ (US); Ting WANG, WEST WINDSOR, NJ (US)

(73) Assignee: NEC Laboratories America, Inc., Princeton, NJ (US)

(21) Appl. No.: 18/938,834

(22) Filed: Nov. 6, 2024

Related U.S. Application Data
(60) Provisional application No. 63/596,687, filed on Nov. 7, 2023.

(51) Int. Cl. G01S 5/22; G01S 5/20

(52) U.S. Cl. CPC G01S 5/22; G01S 5/20

(57) ABSTRACT

Integrated DFOS systems and methods for 3D gunshot, localization, and tracking utilizing Artificial Intelligence enhanced (AI-enhanced) systems and methods for infrastructure security including electrical substations. Our systems and methods provide a comprehensive solution for substation security enhancement, integrating 3D gunshot localization, real-time tracking, and AI-driven analysis. Utilizing Distributed Acoustic Sensing (DAS) technology, our systems and methods precisely detect and triangulate the origin of gunshots in three-dimensional space. The trajectory of a bullet is determined, providing insights into the direction and potential target within the substation. Al algorithms discern between various acoustic events and provide identification of genuine threats. Upon detecting a potential gunshot, our system automatically correlates related acoustic events, such as the noise of a nearby vehicle, offering context and aiding in threat assessment. Our AI-enhanced system evaluates acoustic signals to determine real-time equipment damage resulting from gunshots, ensuring immediate remedial actions and anticipate potential future incidents.

### CROSS-REFERENCE TO RELATED APPLICATIONS

This application claims the benefit of U.S. Provisional Patent Application Ser. No. 63/596,687 filed Nov. 7, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to an integrated DFOS system for gunshot localization, tracking, and security for infrastructure security.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

Recent events have showcased the vulnerability of infrastructure, and in particular electrical substations, to gunshots. Malicious actors, recognizing the pivotal role substations play in contemporary society, have targeted them, using firearms to cause significant damage. As will be understood and appreciated by those skilled in the art, a single gunshot, if targeted correctly, can damage vital equipment, leading to power outages that can affect thousands of residents and critical services, such as hospitals, emergency services, and transportation networks.

### SUMMARY OF THE INVENTION

An advance in the art is made according to aspects of the present disclosure directed to integrated DFOS systems and methods for enhanced 3D gunshot, localization, tracking and AI-enhanced systems and methods for infrastructure security including electrical substations.

In sharp contrast to the prior art, systems and methods according to aspects of the present disclosure provide a comprehensive solution for substation security enhancement, integrating 3D gunshot localization, real-time tracking, and AI-driven analysis.

Utilizing Distributed Acoustic Sensing (DAS) technology, the systems and methods according to the present disclosure precisely detect and triangulate the origin of gunshots in three-dimensional space. Beyond mere detection, the trajectory of a bullet is determined, providing insights into the direction and potential target within the substation.

Additionally, our inventive systems and methods employs Al algorithms trained on vast datasets to discern between various acoustic events, ensuring accurate identification of genuine threats. Upon detecting a potential gunshot, a system according to the present disclosure can automatically correlate related acoustic events, such as the noise of a nearby vehicle, offering context and aiding in threat assessment.

Furthermore, our AI-enhanced system according to aspects of the present disclosure evaluates the acoustic signals to determine real-time equipment damage, if any, resulting from the gunshot, ensuring immediate remedial actions. This holistic approach not only offers an immediate response to threats but also anticipates potential future incidents, setting a new benchmark in substation security.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing an illustrative substation security system flow according to aspects of the present disclosure.

FIG. 3 is a 3D plot showing illustrative sequential gunshot tracking for movement analysis according to aspects of the present disclosure.

FIG. 4 is a schematic diagram showing illustrative features of systems and methods according to aspects of the present disclosure.

FIG. 5 is a schematic block diagram of an illustrative computing system that may be programmed with instructions that when executed produce the methods/algorithms according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration-can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

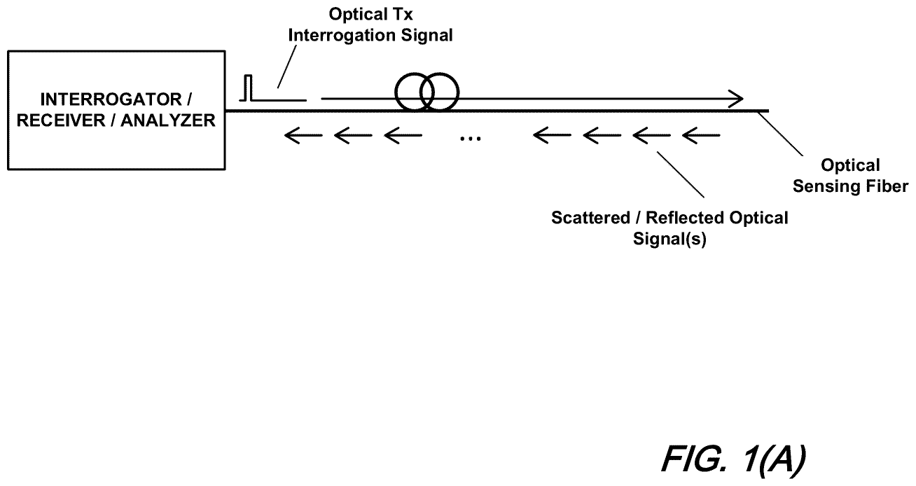

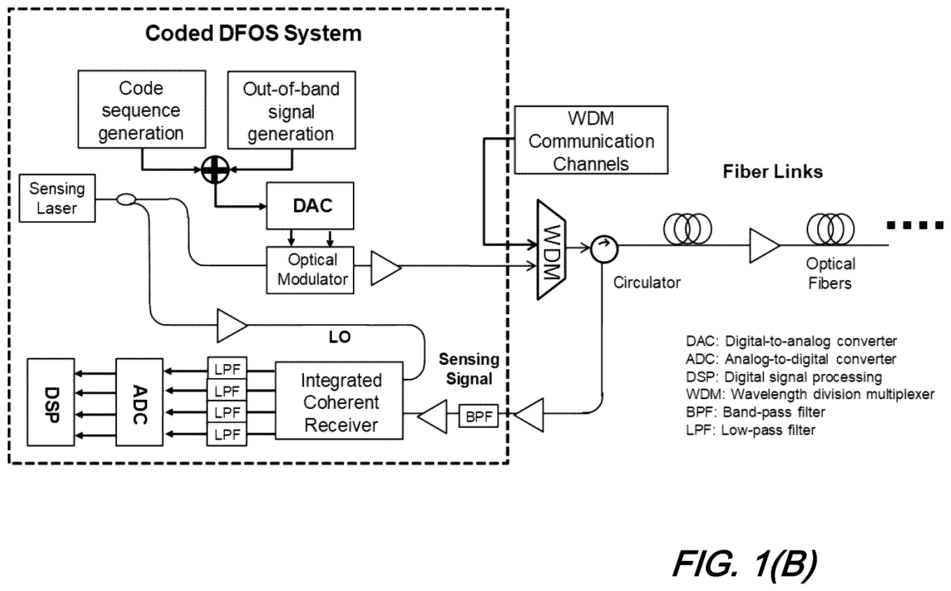

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note once more that our inventive DAS systems and methods are now employed to provide infrastructure security with respect to gunshot damage. More particularly, we describe our inventive DAS system and method that provides gunshot localization with respect to electrical power stations and substations.

We once again note that recent events have showcased the vulnerability of electrical substations to gunshots. Malicious actors, recognizing the pivotal role substations play, have targeted them, using firearms to cause significant damage. A single gunshot, if targeted correctly, can damage vital equipment, leading to power outages that can affect thousands of residents and critical services, such as hospitals, emergency services, and transportation networks.

Those skilled in the art will readily understand and appreciate that while known security measures can deter physical intrusions, they are often ineffective against distant threats such as gunshots fired from a distance. Current systems might be able to detect a breach or unauthorized entry but are ill-equipped to detect, localize, and respond to a gunshot effectively. Furthermore, determining whether a gunshot resulted in equipment damage or merely was an intimidation tactic remains yet another challenge.

Existing gunshot detection systems primarily focus on urban environments, often for crime deterrence in cities. These systems are generally not be optimized for the unique acoustic and environmental conditions of substations. Moreover, they may lack the capability to integrate with other substation management systems or provide real-time tracking and response mechanisms.

Given the evolving nature of threats and the increasing sophistication of malicious actors, there's a pressing need for an advanced solution. Such solution should not only detect and localize gunshots in 3D space but also track their trajectory, assess the damage in real-time, and integrate Al for predictive analysis and immediate response

As we shall show and describe systems and methods according to the present disclosure provide for substation security enhancement, integrating 3D gunshot localization, real-time tracking, and AI-driven analysis. Utilizing Distributed Acoustic Sensing (DAS) technology, the systems and methods according to the present disclosure precisely detect and triangulate the origin of gunshots in three-dimensional space. Beyond mere detection, it tracks the trajectory of the bullet, providing insights into the direction and potential target within the substation.

Additionally, our inventive systems and methods employs Al algorithms trained on vast datasets to discern between various acoustic events, ensuring accurate identification of genuine threats. Upon detecting a potential gunshot, a system according to the present disclosure can automatically correlate related acoustic events, such as the noise of a nearby vehicle, offering context and aiding in threat assessment.

Furthermore, our AI-enhanced system according to aspects of the present disclosure evaluates the acoustic signals to determine real-time equipment damage, if any, resulting from the gunshot, ensuring immediate remedial actions. This holistic approach not only offers an immediate response to threats but also anticipates potential future incidents, setting a new benchmark in substation security.

As those skilled in the art will understand and appreciate, our inventive systems and methods provide a comprehensive solution to the problems outlined, which distinguish their novelty and advances over existing approaches and technologies.

As we shall show and describe and as will become readily apparent to those skilled in the art, our inventive features of our 3D Gunshot localization, Tracking, and Al Enhanced System for Substation Security described herein include the following.

### Distributed Acoustic Sensing (DAS) for Gunshot Detection and Tracking

DAS revolutionizes fiber optic cables, transforming them into a vast array of acoustic sensors that effectively function as continuous fiber microphones. Upon the discharge of a gunshot, a distinct acoustic signature is produced. This signature creates vibrational patterns in the fiber optic cable, which, when analyzed across the cable's span, allow the system to adeptly detect and pinpoint the gunshot's precise location.

### 3D Gunshot Localization

Our inventive systems and methods employ a combination of Time Difference of Arrival (TDOA) and Angle of Arrival (AOA) methodologies. Using fiber microphones placed strategically, the gunshot's sound waves are detected. The system triangulates the gunshot's origin by calculating the differences in arrival times and angles at each sensor. This combined utilization of TDOA and AOA ensures heightened accuracy, particularly in challenging environments with potential echoes or other disturbances.

### Real-Time Gunshot Tracking

Our inventive systems and methods employ phased array techniques that allow the system to dynamically focus its attention on specific directions, enhancing sensitivity and enabling real-time bullet trajectory tracking. Through the analysis of the gunshot sound's frequency change (Doppler shift), the system discerns both the bullet's direction and speed.

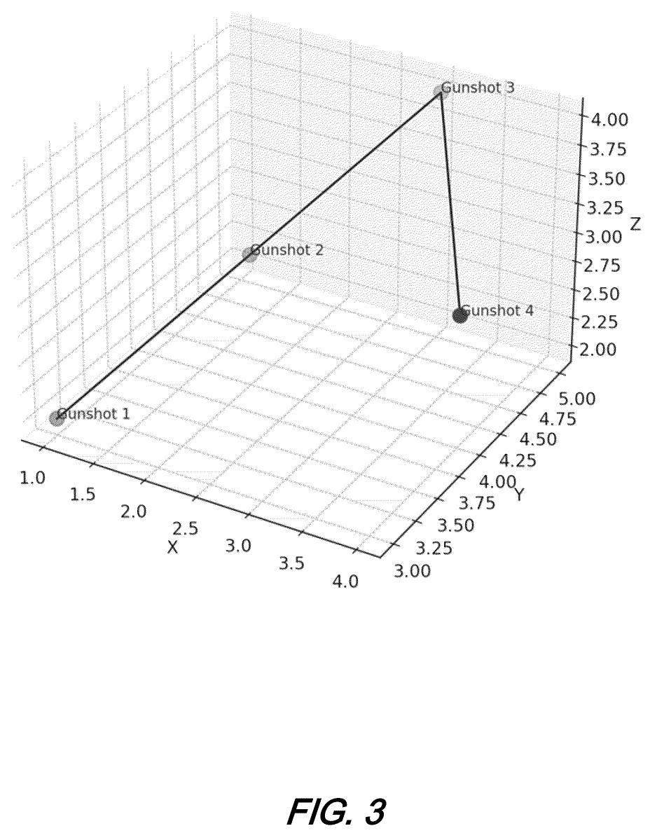

FIG. 3 is a 3D plot showing illustrative sequential gunshot tracking for movement analysis according to aspects of the present disclosure.

### AI-Enhanced Acoustic Analysis

As we shall show and describe, our inventive systems and methods utilize Convolutional Neural Networks (CNN), trained on an extensive dataset encompassing a variety of acoustic events. This model has the finesse to discern even subtle acoustic profile differences, distinguishing, for example, between a genuine gunshot and a car backfiring.

### Damage Assessment Via Acoustic Signals

Our approach involves analyzing post-gunshot acoustic signals, particularly reflections, vibrations, and resonance patterns. Each material, when impacted, emits a unique acoustic signature. Machine learning models, trained on these distinct signatures, can assess the type and extent of damage inflicted.

### Event Correlation

Continuous acoustic data recording, combined with time-series analysis algorithms, provides a holistic view of an event. Upon gunshot detection, the system retrieves data from moments before and after the event, offering context by analyzing associated sounds, such as vehicle noises or voices.

Integration with Local Law Enforcement

Our system integrates seamlessly with local law enforcement communication infrastructures through APIs. Upon threat detection, the system instantaneously sends a comprehensive real-time alert to the appropriate authorities

### Wearable Integration for Security Personnel

We've developed an IoT-based integration connecting wearable devices to the central monitoring system. When an event is detected, the central system dispatches real-time alerts to the wearables. Advanced wearables may offer haptic feedback, directing security personnel towards the event source.

### Adaptive Sensitivity

We've introduced feedback loop algorithms that continuously monitor the current acoustic environment, adjusting system sensitivity in real-time. During noisy periods, the system elevates the detection threshold, minimizing false positives. Conversely, in quieter scenarios, it reduces the threshold to ensure even faint or distant gunshots are detected.

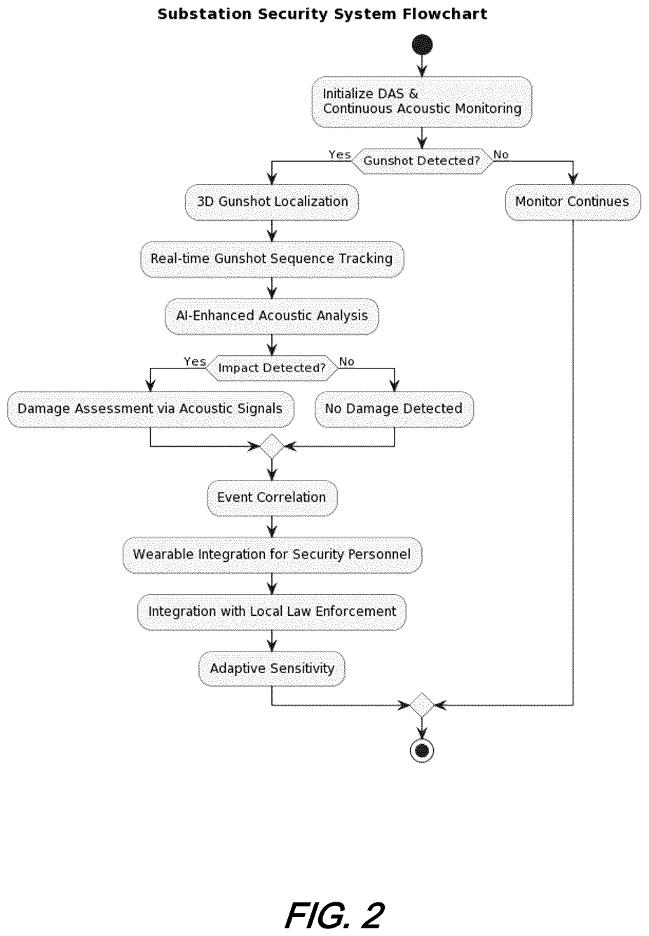

FIG. 2 is a schematic flow diagram showing an illustrative substation security system flow according to aspects of the present disclosure.

### Distributed Acoustic Sensing (DAS) Initialization

### Strategic Deployment of Fiber Optic Microphones

To ensure comprehensive coverage and optimal detection capability, fiber optic microphones are strategically placed within the substation area. For instance, deploying a fiber optic microphone at each corner of the substation ensures a 360-degree monitoring radius. This configuration enhances the system's ability to detect and triangulate acoustic events from any direction.

Integration with the DAS System

Each strategically placed fiber optic microphone is connected to the central DAS system. This integration ensures real-time data transmission and processing. The connection is optimized to minimize latency and maximize data fidelity, ensuring that the vibrational patterns induced in the fiber due to acoustic events are captured with high precision.

### System Calibration for Optimal Performance:

Post-integration, the system undergoes a crucial calibration phase. This involves: i) Generating controlled acoustic events within the substation to simulate potential gunshots or disturbances; ii) Monitoring the fiber optic microphones' responses to these events, adjusting system parameters to ensure accurate and sensitive readings; iii) Tweaking signal processing algorithms to filter out environmental noise and focus on relevant acoustic signatures; and iv) Validating the system's ability to accurately detect and localize these controlled acoustic events, ensuring its readiness for real-world scenarios.

By meticulously following these steps, the DAS system is primed to offer reliable and efficient gunshot detection and localization within the substation environment.

### Continuous Acoustic Monitoring

The DAS system constantly monitors for vibrational patterns along the length of the fiber optic cables. Acoustic data is stored for retrospective analysis, aiding in event correlation.

### Develop 3D Gunshot Localization Algorithm

Upon detecting a potential gunshot sound wave, the system activates the TDOA and AOA methodologies.

Fiber microphones capture the sound waves and send data to the central processing unit.

The system calculates the difference in arrival times and angles at each sensor.

Through triangulation, it determines the gunshot's exact 3D origin.

### TDOA (Time Difference of Arrival) Calculation

For each microphone pair, compute the time difference of the gunshot sound's arrival. Use this time difference and the known speed of sound to calculate the hyperbolic equations for each microphone pair.

Given four microphones labeled M₁, M₂, M₃, and M₄: For any given pair of microphones, the TDOA can be computed. For instance, between M₁, M₂:

$$∇ {t}_{12} = \frac{{d}_{S 1}}{c}$$

Where dₛ₁ is the difference in distance between the gunshot source S to M₁ and M₂, and c is speed of sound. This gives:

$${( {d}_{S 1} - {d}_{S 2} )}^{2} = {c}^{2} ∇ {{t}_{12}}^{2}$$

Similarly, we can have ∇t₁₃, ∇t₁₄ ∇t₂₃, ∇t₂₄, ∇t₃₄ for the other pairs. Each pair provides a unique hyperboloid of potential gunshot locations.

### AOA (Angle of Arrival) Calculation

The Angle of Arrival refers to the angle at which a signal arrives at a sensor (in this case, a microphone). For a 3D system, this angle is represented in two parts: the azimuth angle (∂) and the elevation angle (ϕ).

Azimuth Angle (∂): This angle defines the horizontal direction of the source. It is the angle between the projection of the source signal on the horizontal plane (XY-plane) and a reference direction, often the positive X-axis.

Elevation Angle (φ) This angle represents the vertical inclination of the source. It is the angle between the source signal and its projection on the horizontal plane (XY-plane).

Given a microphone at the origin and a source signal at a point (x, y, z) in 3D space, the angles ∂ and ϕ can be determined using trigonometry:

### For M₁:

1. Azimuth angle ∂₁:

$${θ}_{1} = arctan ( \frac{y}{x} )$$

2. Elevation angle ϕ1:

$${∅}_{1} = arctan ( \frac{\sqrt{{x}^{2} + {y}^{2}}}{z} )$$

Similar formulas would apply to calculate ∂₂, ϕ₂ for M₂, ∂₃, ϕ₃ for M₃, and ϕ₄, pa for M₄.

### Combining TDOA and AOA

Utilize both TDOA hyperbolic equations and AOA directional vectors to triangulate the 3D position of the gunshot. In 3D space, the hyperboloid would look like a “double cone,” and the AOA vector would be a straight line. The point where the line penetrates the surface of the hyperboloid is the computed location of the gunshot.

### Real-time Sequential Gunshot Tracking

As the system detects a series of gunshots, it continuously localizes each shot in real-time. The localized gunshot points are chronologically connected, creating a trajectory that represents the shooter's movement or the sequence of events. By analyzing this trajectory, insights can be drawn about the shooter's potential path or the progression of a particular incident. The following figure presents an illustration of sequential gunshot tracking. By analyzing such a sequence, we can map out the shooter's movement or understand the progression of events. This can be crucial for law enforcement or security personnel to anticipate the shooter's next move or respond more effectively to an ongoing threat.

### AI-Enhanced Acoustic Analysis:

### Data Collection and Preprocessing

Continuous acoustic data from the DAS system is recorded.

This data is segmented into time frames corresponding to potential events.

Features such as frequency domain data, amplitude, and time domain data are extracted for each segment.

### Convolutional Neural Network (CNN) Architecture:

Input Layer: Takes the segmented acoustic data. Each segment can be represented as a 2D array (time vs. amplitude) or a spectrogram (time vs. frequency).

Convolutional Layers: Multiple convolutional layers are used to detect local patterns like short bursts or the characteristic waveforms of gunshots.

Filters in the initial layers might detect simple features like sudden amplitude changes.

Deeper layers can detect more complex patterns like the specific signature of a gunshot.

Pooling Layers: These are interspersed with convolutional layers. They reduce the spatial size of the representation, emphasizing the most important information.

Fully Connected Layers: After several convolutional and pooling layers, the data is flattened and fed into one or more fully connected layers to determine the final classification.

Output Layer: A softmax layer that provides probabilities for each class. For this application, it might have two neurons: one for “gunshot” and another for “not a gunshot”.

### Model Training:

The CNN is trained on a diverse dataset comprising genuine gunshot sounds, environmental noises, and other potential false positives like car backfires or hammer strikes.

Loss functions, such as cross-entropy, are used to optimize the model weights.

Backpropagation and optimization algorithms, like Adam or SGD, adjust the weights based on training performance.

Overfitting is mitigated using dropout layers, data augmentation, and possibly L1 or L2 regularization.

### Real-Time Analysis

The captured acoustic data is fed into the trained CNN model.

The model analyzes the data in real-time, making predictions based on its training.

If the model predicts a “gunshot” class with high confidence, further processing and alert mechanisms are triggered.

### Continuous Model Improvement:

The system can be set up to continuously retrain or fine-tune the model using new data.

Feedback loops can be implemented. If the system misclassifies an event, this can be flagged and the data can be used to further train the model, enhancing its accuracy over time.

### Damage Assessment Via Acoustic Signals:

### Acoustic Signal Capture Post Gunshot

After the gunshot event, the system captures the vibrational patterns produced at the impact point. These patterns contain distinctive signatures based on the type of material hit and the severity of the damage inflicted.

### Pre-Processing and Feature Extraction

The raw acoustic signals are processed to convert them into a format suitable for CNN analysis.

Techniques like Fast Fourier Transform (FFT) are applied to convert these time-domain signals into the frequency domain, bringing out the unique vibrational signatures of impacted materials.

The processed signals are then transformed into spectrogram representations, which provide both time and frequency information in a format that CNNs can efficiently process.

### Convolutional Neural Network (CNN) Architecture

Input Layer: Accepts the spectrogram representation of the acoustic signal.

Convolutional Layers: Multiple layers designed to detect spatial hierarchies and patterns in the spectrogram. These layers can recognize specific vibrational characteristics indicative of different materials and damage levels.

Pooling Layers: These layers reduce the spatial dimensions of the data, preserving essential features while minimizing computational load.

Dense Layers: Interpret the patterns identified by the convolutional layers, leading to a decision about the material type and damage extent.

Output Layer: Provides a classification result indicating the impacted material and an assessment of damage severity.

### Training the CNN

The CNN is trained using a curated dataset of acoustic signals from various materials subjected to impacts. This dataset includes examples of different materials (e.g., metal, concrete, glass) and varying degrees of damage.

Through iterative training, the model learns to distinguish between the unique vibrational signatures of each material and the nuances of damage severity.

### Deployment and Real-time Analysis

Once trained, the CNN is deployed within the DAS system.

In the event of a gunshot, the system rapidly processes the captured acoustic data through the CNN, resulting in a real-time assessment of the impacted material type and damage severity.

### Event Correlation

### Acoustic Data Buffering

The DAS system maintains a rolling buffer of continuous acoustic data. This ensures that data from moments before and after a detected event is readily available for analysis.

This buffer can be user-configurable based on the typical durations of interest (e.g., a few seconds or minutes).

### Trigger-Based Data Retrieval:

Once a potential gunshot is detected, the system then retrieves a predefined duration of acoustic data from the buffer—capturing moments leading up to the gunshot and immediately after.

This offers a temporal context, which can be crucial in understanding the series of events surrounding the gunshot.

Time-Series Analysis with Signal Processing

The extracted acoustic data is processed using signal processing techniques such as FFT to highlight prominent acoustic features.

The system then employs time-series clustering algorithms to group similar acoustic patterns, helping identify repetitive or associated events.

### Identification of Associated Sounds

The algorithms search for recognizable acoustic signatures, such as vehicle engine sounds, footsteps, voices, or other gunshots.

We will use pretraind machine learning models that trained on a wide array of environmental and event-driven sounds to aid in this identification.

### Temporal Contextualization

By analyzing the time intervals between associated sounds, the system can piece together a timeline of events. For example, if an engine noise is detected shortly before a series of gunshots, it might indicate a drive-by shooting scenario.

### Real-Time Reporting

All identified associated sounds and their temporal sequence are immediately reported to the central monitoring system.

This comprehensive acoustic context aids in understanding the broader scenario, supporting decision-making processes for security personnel and law enforcement.

Integration with Local Law Enforcement

The system activates the pre-configured API integration with local law enforcement communication systems. It sends a comprehensive real-time alert detailing the event's specifics. Law enforcement agencies receive the alert and can act swiftly.

### Wearable Integration for Security Personnel

When an event is detected, the central system communicates with connected wearables through IoT protocols.

Real-time alerts are dispatched to the wearables.

Advanced wearables provide haptic feedback, offering direction and context to security personnel.

### Adaptive Sensitivity

The system's feedback loop algorithms monitor the prevailing acoustic environment. These algorithms employ machine learning models trained on diverse acoustic environments to predict the best sensitivity setting under the current conditions.

Based on the detected noise levels, the system adjusts its sensitivity threshold in real-time. For example, If the system detects a consistently noisy environment (e.g., due to nearby construction or heavy traffic), it raises the threshold for gunshot detection to reduce false positives. Conversely, in quieter periods, the threshold is lowered to ensure detection of even distant or muffled gunshots. This dynamic sensitivity adjustment ensures that the system remains alert and effective in detecting gunshots across varying acoustic conditions, minimizing false alarms while ensuring genuine threats are identified

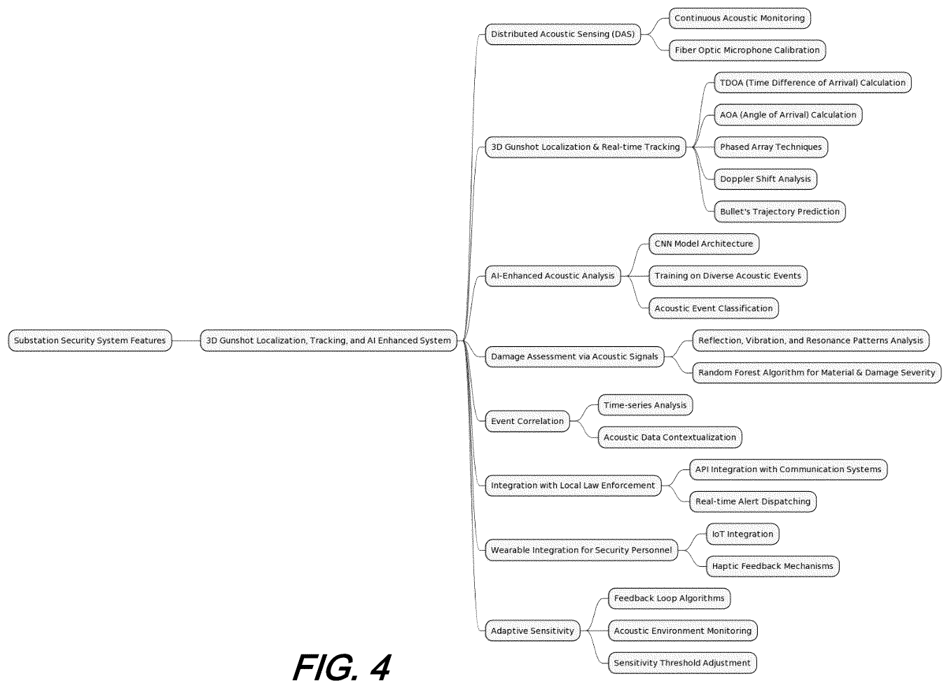

FIG. 4 is a schematic diagram showing illustrative features of systems and methods according to aspects of the present disclosure.

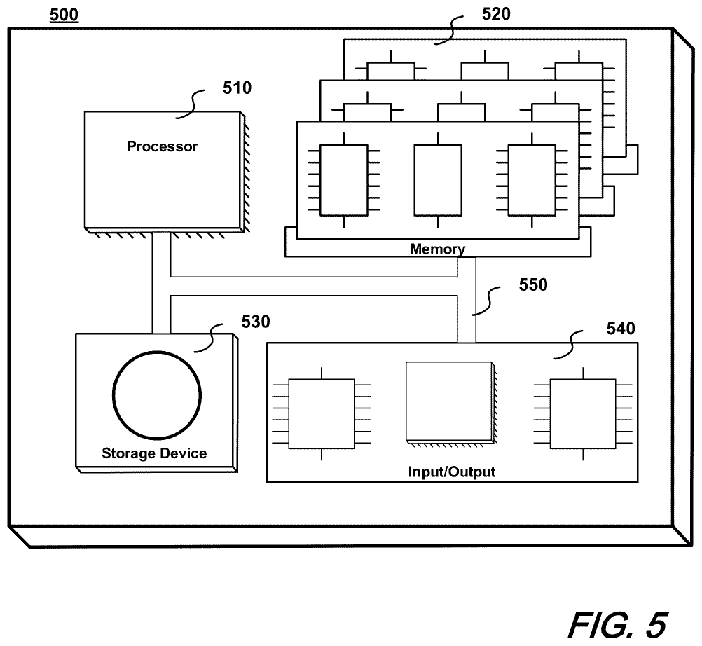

FIG. 5 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 500 as stored program control instructions.

Computer system 500 includes processor 510, memory 520, storage device 530, and input/output structure 540. One or more input/output devices may include a display 545. One or more busses 550 typically interconnect the components, 510, 520, 530, and 540. Processor 510 may be a single or multi core. Additionally, the system may include accelerators etc., further comprising the system on a chip.

Processor 510 executes instructions in which embodiments of the present disclosure may comprise steps described in one or more of the Drawing figures. Such instructions may be stored in memory 520 or storage device 530. Data and/or information may be received and output using one or more input/output devices.

Memory 520 may store data and may be a computer-readable medium, such as volatile or non-volatile memory. Storage device 530 may provide storage for system 500 including for example, the previously described methods. In various aspects, storage device 530 may be a flash memory device, a disk drive, an optical disk device, or a tape device employing magnetic, optical, or other recording technologies.

Input/output structures 540 may provide input/output operations for system 500.

FIG. 5 is a schematic diagram showing illustrative features of systems and methods according to aspects of the present disclosure.

While we have presented our inventive concepts and description using specific examples, our invention is not so limited. Accordingly, the scope of our invention should be considered in view of the following claims.

1. A system for substation security comprising:
a distributed fiber optic sensing (DFOS)/distributed acoustic sensing (DAS) system;
the substation security system including circuitry configured to:
detect and localize acoustic events including gunshots from DAS data using time difference of arrival (TDOA) and angle of arrival (AOA) methodologies.

2. The system of claim 1 configured to triangulate the gunshots origin by determining differences in arrival times and angles of the gunshot acoustic events detected by the DAS at a plurality of DAS sensor fiber locations.

3. The system of claim 2 configured to determine real-time bullet trajectory of the gunshot acoustic events detected.

4. The system of claim 3 configured to determine the real-time bullet trajectory including bullet direction and speed from the gunshot acoustic events frequency change.

5. The system of claim 1 further comprising one or more convolutional neural networks (CNN), the system configured to distinguish gunshot acoustic events from other, non-gunshot acoustic events.

6. The system of claim 5 configured to distinguish a type and extent of damage to the substation resulting from bullet impacts.

7. The system of claim 6 configured to distinguish the type and extend of damage to the substation resulting from bullet impacts includes analyzing post-gunshot acoustic signals comprising reflections, vibrations, and resonance patterns.

8. The system of claim 7 configured to provide gunshot event correlation to acoustic events occurring before and after the gunshot event.

9. The system of claim 8 wherein the acoustic events occurring before and after the gunshot event include vehicle noises and voices.

10. The system of claim 8 wherein the angle of arrival is the angle at which an acoustic signal arrives at a sensor and is defined by an azimuth angle and an elevation angle.

11. The system of claim 8 wherein TDOA hyperbolic equations and AOA directional vectors are used to triangulate a 3D position of gunshot.
